(19) United States
(12) Patent Application Publication
(10) Pub. No.: US 2004/0111951 A1
(43) Pub. Date: Jun. 17, 2004

(54) Fishing lure with reflective gill plate and method of making same

(76) Inventor: Herb Reed, Southington, CT (US)

Correspondence Address: Timothy A. Johnson, McCormick, Paulding & Huber LLP, City Place II, 185 Asylum Street, Hartford, CT, 06103, US

(21) Appl. No.: 10/317,316

(22) Filed: Dec. 12, 2002

(51) Int. Cl. A01K 85/00

(52) U.S. Cl. 43/42.32

(57) ABSTRACT

A flexible fishing lure having a reflective portion and a method of making same is disclosed herein. The flexible fishing lure has a reflective portion encapsulated within a flexible body portion. The body portion is preferably translucent or transparent so as not to diminish the reflectivity of the reflective portion. Reflective particles may be controllably dispersed within the body portion to provide a reflective portion. A most preferred embodiment is a flexible fish shaped lure having one or more reflective gill plates.

### BACKGROUND OF THE INVENTION

1. Field of the Invention

This invention relates to fishing lures and methods of making fishing lures.

2. Description of Related Art

Artificial baits and lures are available in a wide variety of forms, colors and designs. Artificial lures may be made from metal, wood, hard plastic or a flexible polymeric or elastomeric material shaped as a smaller bait fish, other prey or a fanciful manner. Some metal lures reflect light and move in such a way as to attract fish to the source of activity. They also stimulate and excite the fish, causing the fish to bite and attack objects in the water as possible food sources. Flexible fishing lures are preferable in certain situations since they better mimic the appearance and fleshy feel of natural prey to a striking predator fish. Certain predator fish are more likely to strike a flexible bodied lure than a rigid bodied lure for that reason. Thus, it would be advantageous to combine the useful reflective qualities of some lures and the flexible qualities of other lures to attract a fish to the lure, and once there, to present a reasonable appearance and feel of actual prey.

Gamefish have long been known to be attracted to, and to feed on, smaller fishes. It is also known that predators tend to strike at the front end, or head of these preyfish because their chances of a successful capture are higher when doing so. The spiny fins of many prey species present difficulties for the predator in swallowing them other than head first. Further, it is known to those skilled in the art that gamefish are more apt to strike at prey and, consequently, at lures that imitate prey when the head or front end of the prey is easily identifiable. The flash given off by the reflective gill plates of many preyfish species is among the best visual definitions of the head area. Thus, the incorporation of a realistically reflective representation of gill plates into artificial lures will increase the effectiveness of such lures in attracting and provoking a strike response from predatory fish.

Bearing in mind the problems and deficiencies of the prior art, it is therefore an object of the present invention to provide a lure that overcomes the drawbacks and deficiencies of the prior art.

### SUMMARY OF THE INVENTION

The above and other objects and advantages, which will be apparent to one of skill in the art, are achieved in the present invention which is directed to, in a first aspect, a fishing lure comprising: a body formed from a flexible first material; and an inner portion formed from a second material different from the first material being completely encapsulated by the first material, the inner portion defining an outwardly facing reflective surface. Preferably, the fishing lure is fish shaped and the reflective portion comprises one or more gill plates.

In another aspect, the present invention is directed to a method of making a fishing lure comprising the steps of: forming a body portion comprising a flexible polymeric material; placing a reflective portion on the body portion; and encapsulating the reflective portion within the body portion.

### BRIEF DESCRIPTION OF THE DRAWINGS

FIG. 1 is a side view of a preferred embodiment of a fishing lure of the present invention.

FIG. 2 is a cross sectional view of the preferred embodiment of FIG. 1 taken at lines 2-2.

FIG. 3 is a side view of another preferred embodiment of the present invention.

FIG. 4 is a cross sectional view of another preferred embodiment of the present invention.

### DESCRIPTION OF THE PREFERRED EMBODIMENT(S)

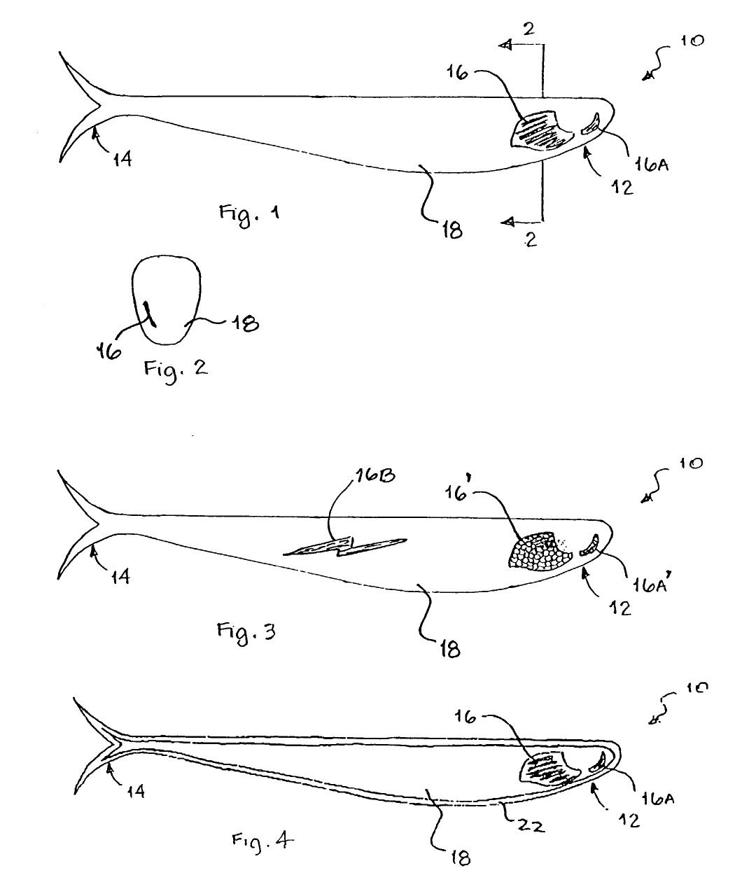

A preferred embodiment of the present invention is shown in FIG. 1 wherein fishing lure 10 has the shape of a prey fish although any shape of lure 10 is contemplated. Lure 10 has a head end 12, a tail end 14, and body portion 18. The term “body portion” shall be construed to include any appendages extending therefrom. Reflective portion 16 is visible on a side plane view of lure 10. Both sides of lure 10 may show corresponding reflective portions. As shown in FIG. 1, reflective portion 16 is shaped to resemble a gill plate of the prey fish. Reflective portion 16A is included to more realistically resemble the gill plate of a prey fish. These reflective portions are visible within body portion 18 of lure 10. For a more realistic prey fish, a decorative eye (not shown) adjacent head end 12 may be present and visible within body portion 18. To further enhance the reflectivity of the lure, reflective particles (not shown) may also be present within body portion 18.

The reflective portions of lure 10 may comprise of foil, plastic, mylar, mica, or other suitable reflective material that is different from, but compatible with, the material which makes up body portion 18. Preferably, reflective portions 16 and 16A are cut from sheets of reflective material which can be placed and positioned on body portion 18 during formation of body portion 18. In FIG. 2, reflective portion 16 is placed adjacent to an outer surface of body portion 18 so that reflective portion 16 is visible and its reflectivity is not substantially diminished. Although reflective portions 16 and 16A comprise a gill plate in FIG. 1, other reflective shapes may be positioned within body portion 18. For example, a reflective logo and/or fanciful design 16B may be incorporated into body portion 18 as seen in FIG. 3.

Alternatively, reflective portions 16 and 16A may comprise of a plurality of small reflective particles which are controllably dispersed in a part of body portion 18 or cast in a flexible material into a desired shape and positioned on or within body portion 18. This is shown in FIG. 3 wherein reflective portions 16′ and 16A′ are made up of a plurality of reflective particles controllably dispersed within body portion 18. The reflective particles can comprise of glitter or POLYFLAKES™.

Body portion 18 is preferably made from a fleshy, flexible, memory retentive material that is preferably moldable and may have one or more colors. As used herein, the term “flexible” is to be construed to mean that the material from which the body portion of the lure made is flexible and elastomeric or polymeric material, including but not limited to, vinyl, latex, silicone polymer or similarly pliable materials. It may also be translucent or opaque as long as it does not detract from the reflective portions of the lure. Body portion 18 may be made by a stamping, molding or dipping process. Body portion 18 is preferably solid but may have voids or bubbles from the manufacturing process which would not detract from the definition of solid. While the body portion is curing or solidifying, reflective portions can be placed and positioned on body portion 18 so that the reflective portions will adhere onto the surface of body portion 18 prior to fully encapsulating the reflective portions with additional flexible material of body portion 18. Flexible fins or other details of aquatic creatures may be incorporated into the shape of body portion 18.

Body portion 18 may also include other compatible materials which can provide different colors to lure 10. Reflective portion 16 may be encapsulated within another elastomeric material 22, which may be another color, prior to complete formation of body portion 18 as shown in FIG. 4. It is preferred that body portion 18 comprise a single material for ease of manufacturing.

In another preferred embodiment of the present invention, the fishing lure of the present invention can be made by forming a body portion from a flexible, material preferably using a stamping, molding or dipping process; positioning on the body portion a reflective portion, comprising a material different from the material of the body portion, which may, for example, be a gill plate if the inner portion is shaped as a prey fish; and encapsulating the reflective portion within the body portion, preferably by a molding or dipping process. Preferably, the reflective portion is positioned on or into the body portion during the early stages of curing or solidifying the body portion prior to encapsulation.

The present invention achieves the objective recited above. The flexible lure of the present invention has a reflective portion which stimulate and excite fish while mimicking the fleshy feel of natural prey to a striking predator fish. A lure of the present invention more realistically represents the flash given off by the reflective gill plates of many preyfish species, thereby increasing the effectiveness in attracting and provoking a strike response from predatory fish. The method of making a flexible lure having a reflective portion of the present invention provides a simple way of incorporating the reflective portion into the flexible lure.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A fishing lure comprising:
a body formed from a flexible first material; and
an inner portion formed from a second material different from
the first material, said inner portion completely encapsulated by
the first material and defining an outwardly facing reflective surface.

2. The fishing lure of claim 1 wherein said body portion further comprises additional flexible materials.

3. The fishing lure of claim 1 wherein said body is fish shaped and said inner portion is a reflective gill plate.

4. The fishing lure of claim 1 wherein said inner portion comprises a reflective material selected from the group consisting of foil, plastic, mylar, and mica.

5. The fishing lure of claim 1 wherein said inner portion comprises a plurality of reflective particles controllably dispersed within said body portion.

6. A fishing lure comprising:
a fish shaped body of flexible material having a head and a tail end; and
a reflective gill plate located adjacent the head of said fish shaped body, said reflective gill plate comprising a material different from said body and completely encapsulated by said body.

7. The fishing lure of claim 6 further including a second reflective gill plate.

8. The fishing lure of claim 7 wherein each reflective gill plate is positioned on either side of said fish shaped body adjacent the head of said fished shaped body.

9. The fishing lure of claim 6 wherein said reflective gill plate comprises a reflective material selected from the group consisting of foil, plastic, mylar, and mica.

10. The fishing lure of claim 6 wherein said reflective gill plate comprises a plurality of reflective particles controllably dispersed within said fish shaped body.

11. A method of making a fishing lure comprising the steps of: forming a body portion comprising a flexible polymeric material; placing a reflective portion on the body portion; and encapsulating the reflective portion within the body portion.

12. The method of claim 11 wherein the step of forming the body portion comprises dipping, molding or stamping.

13. The method claim 11 wherein in the step of forming a body portion, the body portion is shaped like a fish having a head end and a tail end.

14. The method of claim 13 wherein the step of placing a reflective portion on the body portion comprises placing a reflective gill plate on the body portion adjacent the head end of the fish shaped body portion.

15. The method of claim 11 wherein the step of placing the reflective portion on the body portion comprises controllable dispersing a plurality of reflective particles within the body portion.

16. The method of claim 11 wherein in the step of placing a reflective portion on the body portion comprises placing a reflective portion comprising a reflective material selected from the group consisting of foil, plastic, mylar, and mica.
